(19) United States
(12) Patent Application Publication
(10) Pub. No.: US 2017/0371415 A1
(43) Pub. Date: Dec. 28, 2017

(54) TACTILE USER INTERFACE

(71) Applicant: Intel Corporation, Santa Clara, CA (US)

(72) Inventors: Rafi Cohen, Modiin (IL); Tal Marian, Tel Aviv (IL)

(21) Appl. No.: 15/195,704

(22) Filed: Jun. 28, 2016

(51) Int. Cl. G06F 3/01; G06F 3/041; H04M 1/725

(52) U.S. Cl. CPC G06F 3/016; H04M 1/72533; G06F 3/0414; G06F 3/0416

(57) ABSTRACT

Disclosed in some examples are methods, systems, and machine readable mediums which provide for an improved, tactile user interface. Rather than being limited to two dimensions (temporal patterns and intensities), the disclosed tactile communications utilizes additional dimensions. These added dimensions allow for the tactile interface of the present disclosure to convey significantly more information than the vibration notifications previously used.

### TECHNICAL FIELD

Embodiments pertain to tactile user interfaces. Some embodiments relate to tactile communications.

### BACKGROUND

The traditional user interface for mobile devices (e.g., smartphones, wearables, and the like) is usually a touchscreen display. Touchscreen displays rely both upon human sight (to see the display) and touch (to enter input). These displays involve capacitive or resistive sensors which measure the position of a user's touch.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a diagram of a one-to-one reproduction of a tactile sequence comprising a single touch point according to some examples of the present disclosure.

FIG. 1B is a diagram of a one-to-one reproduction of a tactile sequence comprising a single touch point according to some examples of the present disclosure.

FIG. 2A is a diagram of a reproduction of a tactile sequence of a single touch point according to some examples of the present disclosure.

FIG. 2B is a diagram of a reproduction of a tactile sequence of a single touch point according to some examples of the present disclosure.

FIG. 3A shows a back surface of a mobile device with a backplate with an array of holes which allow one or more pins to protrude through when activated according to some examples of the present disclosure.

FIG. 3B shows a side view of the mobile device of FIG. 3A according to some examples of the present disclosure.

FIG. 4 shows an example side view schematic of a single pin in a shaft according to some examples of the present disclosure.

FIG. 5 shows a diagram of one example tactile sequence of eight touch points according to some examples of the present disclosure.

FIG. 6 shows a diagram of another example tactile sequence of four touch points according to some examples of the present disclosure.

FIG. 7 shows a flowchart of a method of recording a tactile sequence according to some examples of the present disclosure.

FIG. 8 shows a sub-flowchart of a method of recording tactile information according to some examples of the present disclosure.

FIG. 9 shows a sub-flowchart of an example method of recording tactile information using events according to some examples of the present disclosure.

FIG. 10 shows a sub-flowchart of an example method of recording tactile information using events according to some examples of the present disclosure.

FIG. 11 shows a sub-flowchart of an example method of recording tactile information using events according to some examples of the present disclosure.

FIG. 12 shows a flowchart of a method of utilizing a tactile sequence as a notification on a mobile device according to some examples of the present disclosure.

FIG. 13 shows a flowchart of a method of receiving a tactile sequence as a communication from another user according to some examples of the present disclosure.

FIG. 14 shows a sub-flowchart of a method of delivering a tactile sequence according to some examples of the present disclosure.

FIG. 15 shows a logical schematic of a mobile device according to some examples of the present disclosure.

FIG. 16 is a block diagram illustrating an example of a machine upon which one or more embodiments may be implemented.

### DETAILED DESCRIPTION

There are a few problems with the use of touchscreen displays as a primary user interface. First, mobile devices are under a dual tension to both reduce size to improve portability and increase the size devoted to the touch screen. On the one hand, it is desired to have a large screen for ease of viewing and ease of entering data. Smaller screens can strain a user's eyes and present difficulty in selecting keys on a touch screen keyboard, however larger screens are bulky and difficult to carry around. Similarly, for wearables, designing a user interface that is large enough to be sufficiently usable but small enough to be comfortable is also a challenge. Typically manufacturers have solved this by limiting the amount of information available on a user interface of the wearable and increasing the display size (e.g., the font size) of that information.

A second problem with touchscreen displays is that communicating through a touch screen display requires a user to focus their eyes and attention to the touch screen display. This is often not very discrete. Users may wish to receive notifications and other messages in a way that is not noticeable. While current mobile devices provide the option for also receiving notifications via sound or vibrations in one or more patterns and intensities, sound notifications are not discrete and vibration notifications convey little information as they originate from a single vibration point.

Disclosed in some examples are methods, systems, and machine readable mediums which provide for an improved tactile user interface. The tactile interface utilizes one or more tactile reproduction units to stimulate a touch sense of the skin of the user. These tactile reproduction units may include vibrators, pins, electrical contacts or the like. In contrast to traditional vibration notifications or other touch-based feedback, the currently disclosed tactile communications allows for spatial dimensionality. For example, the tactile reproduction units may provide a spatial dimension to the stimulation by being arranged so as to provide multiple different stimulation points along a two-dimensional axis (e.g., an X and Y axis) of a surface in contact with the user's skin. This provides a spatial dimension to the tactile user interface that is not present in current devices such as vibrators (which only allow timing patterns and intensities). A plurality of tactile reproduction units (e.g., a plurality of vibrators, electrical contacts, or pins) in some examples may be arranged in a matrix like or other spatial pattern in order to provide this spatial dimensionality. In some examples, the tactile reproduction units may be a combination of different types (e.g., various combinations of pins, vibrators, and/or electrical contacts).

The spatial dimension may be combined with the time dimension to impart a feeling of motion of the tactile sequence. For example, the tactile reproduction units that are activated (and providing stimulation) at any one time may change over time to simulate a moving touch. In addition to spatial and motion dimensions, the current tactile user interface also allows for variations in intensity of the stimulation, variations in the time the stimulation is applied, and the like. As a result, the tactile interface of the present disclosure is able to convey significantly more information than the vibration notifications previously used. For example, users may be able to relay complex messages between each other utilizing motion location, patterns, and intensities. In some examples, the tactile reproduction units may be activated in such a way as to simulate a human touch on the skin of a user.

Users may record one or more touch sequences through a touch screen (or other input device) and the device (or another user's device) may “play-back” this touch pattern by simulating the original physical touch of the person who recorded the touch sequences using the tactile reproduction units. When recording the touch sequences, the mobile device may take sensor readings, such as touch location, motion, pressure, warmth, and other touch and tactile sequence characteristics which are later reproduced by controlling which of the tactile reproduction units are actuated (for spatial dimensionality), varying the intensities of the vibrations, varying the distance of travel in the pins, varying the current applied to the electrical contacts, or the like in order to reproduce the pressure or intensity of the touch, and changing which reproduction units are activated over time to simulate motion.

The tactile interface may be on the back of a smartphone or other wearable and may replace or supplement the primary user interface (e.g., a touchscreen). The tactile interface may be on a surface of the mobile device that is in contact with a user's skin. In some examples, this may be a surface opposite of the primary user interface.

The use of tactile communications allows the mobile device to improve user interfaces of mobile devices by introducing new forms of communication that do not depend on screen size and thus allow for devices with smaller screens to communicate additional information without having to increase the screen size (and thus device size). Furthermore, tactile communications offers a discreet form of communication that allows users to communicate without having to rely on their eyes. While this method improves user interfaces of mobile devices, it will be appreciated by one of ordinary skill that the methods, systems, devices, and machine readable mediums disclosed herein may improve user interfaces of other computing devices as well.

As used herein, tactile sequences include a set of one or more touch points. Touch points are discrete touches (e.g., a finger press) which have touch point characteristics. Touch point characteristics may include location (X, Y positions), pressure, warmth, and the like. Tactile sequences with more than one touch point include one or more tactile sequence characteristics including the ordering of the touch points within the tactile sequence, delay between each successive pair of touch points, speed of a successive pair of touch points, and the like. Tactile sequences may include multiple touch points that overlap in time so that multi-touch tactile communications are possible. Through the use of sequences of touch points, tactile motion may be detected, stored, transmitted, and reproduced. While the present disclosure utilizes tactile sequences and touch points, one of ordinary skill will understand with the benefit of the present disclosure that this representation of a touch is exemplary and that other representations may be utilized. For example, while the present disclosure defines motion as a series of touch points over time, the tactile sequence may be described by start and end touch points and the tactile reproduction units may interpolate points in-between.

As previously noted, a tactile sequence may be reproduced using one or more tactile reproduction units. Example tactile reproduction units include pins, electrical contacts that deliver tiny but detectable currents, vibration devices, and the like. These tactile reproduction units may be arranged in various ways to reproduce the tactile communication. The tactile reproduction units may be positioned in a grid pattern, a triangle, a square, a circle, or other geometric shape. In some examples, the input touch is translated into output stimulation such that there is a one-to-one translation of the tactile input to activation of the tactile reproduction units. In other examples, the tactile reproduction units may simulate a one-to-one translation using interpolation. For example, tactile reproduction units may vary their intensity of activation to simulate a touch at a point between the tactile reproduction units. In still other examples, a loss of resolution is accepted—that is, the resolution of the touch sensors is higher than that of the tactile reproduction units—and no compensation is performed.

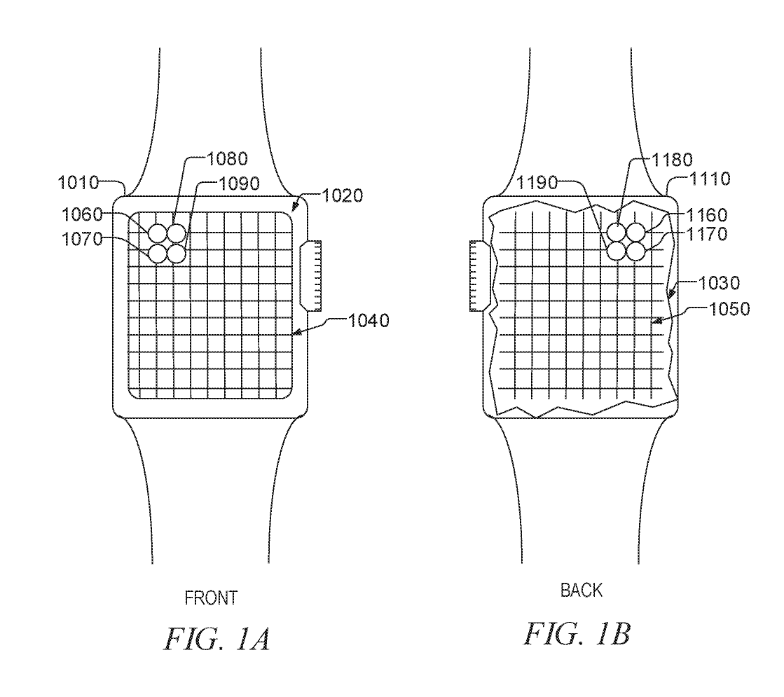

FIG. 1A and FIG. 1B are diagrams of a one-to-one reproduction of a tactile sequence comprising a single touch point according to some examples of the present disclosure. FIG. 1A shows a front surface 1020 of the wearable device 1010 (in the form of a watch) including a touch screen display 1040 including one or more touch sensors. Touch screen display 1040 may be a capacitive or resistive touchscreen. In some examples, the touch screen may be a typical touch screen utilized in present smart devices, but in other examples, additional sensors may sense touch characteristics such as heat of the touch, pressure, and the like.

The various input positions that are sensible are shown in FIG. 1A as a grid pattern. Each intersection of a vertical and horizontal line is a position on the touchscreen in which a touch is capable of being sensed. In the case of a human finger, a touch may activate more than one sensor, as is illustrated in FIG. 1A in which a finger has activated multiple sensors. Activated sensors are represented by circles 1060, 1070, 1080, and 1090. In some examples, these locations will translate to activation of corresponding tactile reproduction units. FIG. 1B shows a back surface 1030 which is shown cut-away to show the grid of tactile reproduction units 1050. Each point formed by the intersection of a horizontal and vertical line is the location of a tactile reproduction unit. Tactile reproduction units that are to be activated to reproduce the touch entered on the front of the device are shown with circles 1160, 1170, 1180, and 1190. These circles correspond to the same (X,Y) location (with respect to the respective grids) on a back surface 1030 of the device 1110 as the touch input on the front 1020 of the device 1010. In some examples, device 1010 and 1110 are the same device and 1020 is the front and 1030 are back surfaces of the same device, but in other examples, device 1010 and 1110 are different devices. As shown the tactile reproduction units are behind the back surface of the device 1110, but in other examples, the tactile reproduction units may protrude through the back surface 1030. For example, electro-magnetic pins may slide up and back through shafts as a result of electrical current applied to the shaft or pins. These shafts may be centered on a point where the horizontal and vertical lines are shown 1050. As shown, the position of the touch is transferred to a corresponding touch position on the back of the device.

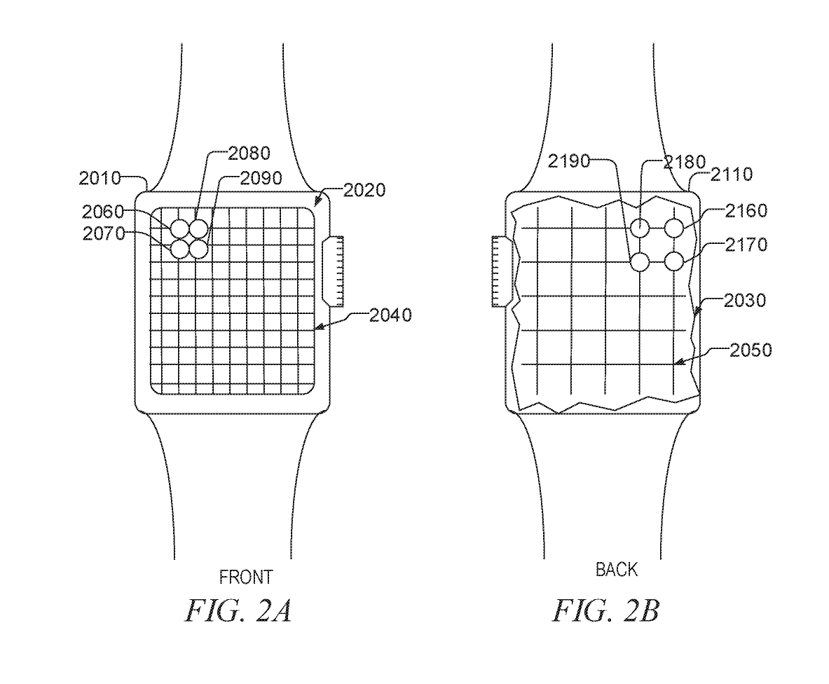

FIGS. 2A and 2B are diagrams of a reproduction of a tactile sequence of a single touch point according to some examples of the present disclosure. In FIG. 2B, there are fewer tactile reproduction units than touch input points. In these examples, the touch may be reproduced by activating the nearest tactile reproduction unit(s) and adjusting an intensity of the tactile units so that the touch feels as if it were exactly reproduced. For example, intensity may be increased for touch points closer to the intended position and decreased for touch points farther away. As shown, the mobile device 2010 includes front surface 2020 and a touch screen display 2040 with sensor input locations shown as intersecting horizontal and vertical lines. Just as with FIG. 1, sensors at points 2060, 2070, 2080, and 2090 are activated. Unlike with FIG. 1, the back 2030 of the device 2110 has fewer tactile reproduction units 2050 than there are sensor input locations on the touch screen 2040 of the front 2020. In this case, points nearest to the intended position may be activated, in this case 2160, 2170, 2180, and 2190. In this case however, points closest the intended location may be activated more strongly than points farther from the intended location. While in this example, there were four points, in other examples, there may be three points (e.g., the position may be triangulated). In still other examples, the number of tactile reproduction units may be greater than a resolution of the touch sensor.

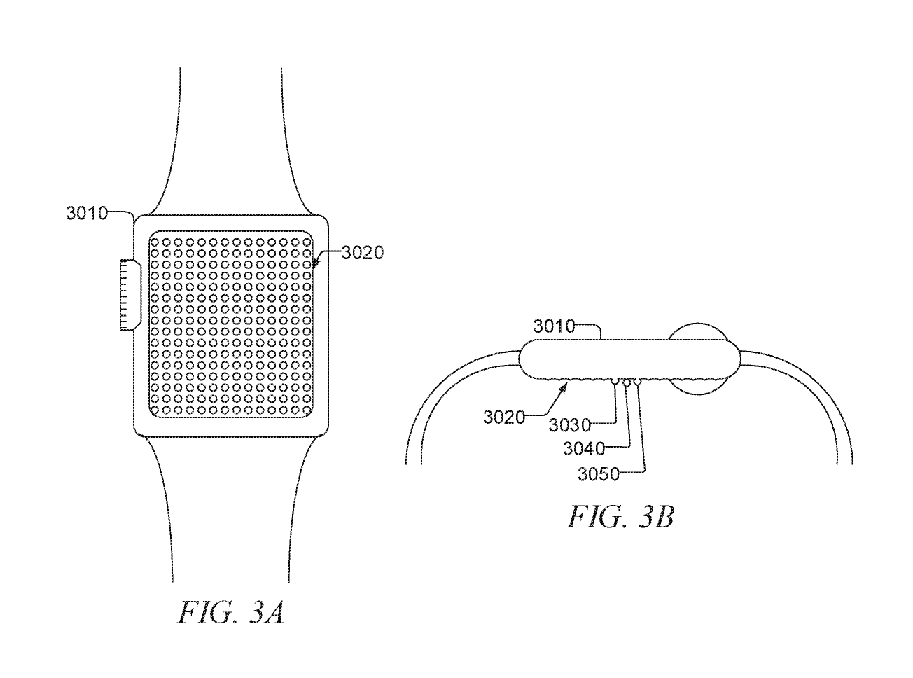

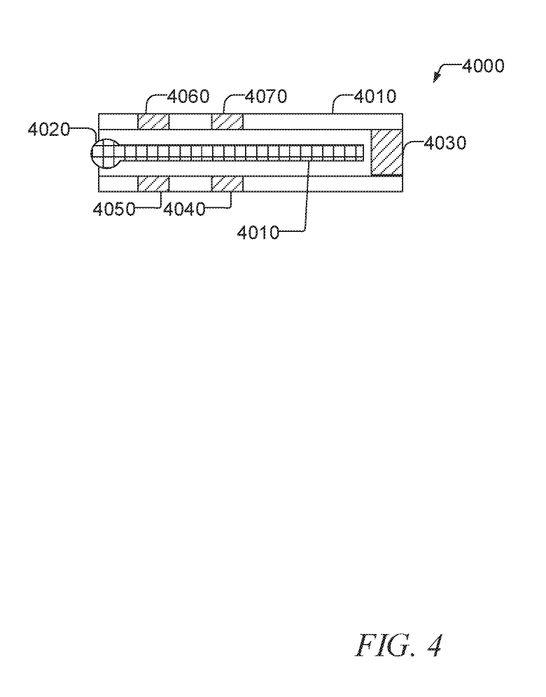

As is already explained one example type of tactile reproduction units may be metal pins. FIG. 3A shows a back surface of a mobile device 3010 with a backplate 3020 with an array of holes which allow one or more pins to protrude through when activated. In some examples, the pins may be individually actuated such that each pin is independently controllable from the others. FIG. 3B shows a side view of the mobile device 3010. The backplate 3020 is shown (the holes represented by small bumps). Pins 3030, 3040, and 3050 have been activated and are protruding downward. As shown in FIG. 3B, the pins 3030, 3040 and 3050 are each activated a different amount—that is, in some examples, the pins may be extended different amounts (e.g., depending on the amount of electric current applied to move them or depending on which electromagnets are activated, as will be explained with the discussion of FIG. 4). This may allow for the creation of patterns and varying intensity.

FIG. 4 shows an example side view schematic of a single pin 4020 in a shaft 4010 according to some examples of the present disclosure. In some examples many of these may be connected together and wired to a microcontroller or processor such that a processor may control the extension or retraction of each of the pins to reproduce a tactile sequence. In this example, the pin 4020 may be magnetically charged and the one or more electromagnets 4030-4070 may repel or attract the magnetically charged pin through the application of electrical current to one or more of the electromagnets 4030-4070. For example, if the negative pole of the pin 4020 is nearest the electromagnet 4030, an application of electrical current so as to create a negative magnetic field in the vicinity of the negative pole of the pin 4020 will act to extend the pin 4020. Similarly, application of electrical current so as to create a positive magnetic field in the vicinity of the negative pole of the pin 4020 will act to retract the pin 4020. The amount of retraction may be a function of the strength of the current applied (thus affecting the strength of the magnetic field). Additional electromagnets 4040-4070 may allow for more fine grained control of the amount of extension of the pin through application of current so as to attract or repel the pin. In some examples, each shaft may be magnetically shielded from the magnetic fields of other shafts (e.g., by a nickel-iron soft magnetic alloy called Mu-metal) to allow for individual control of the pins. It should be appreciated that the method shown in FIG. 4 is but one of the possible ways that such a pin mechanism could be implemented and other ways will be appreciated by one of ordinary skill with the benefit of the present disclosure.

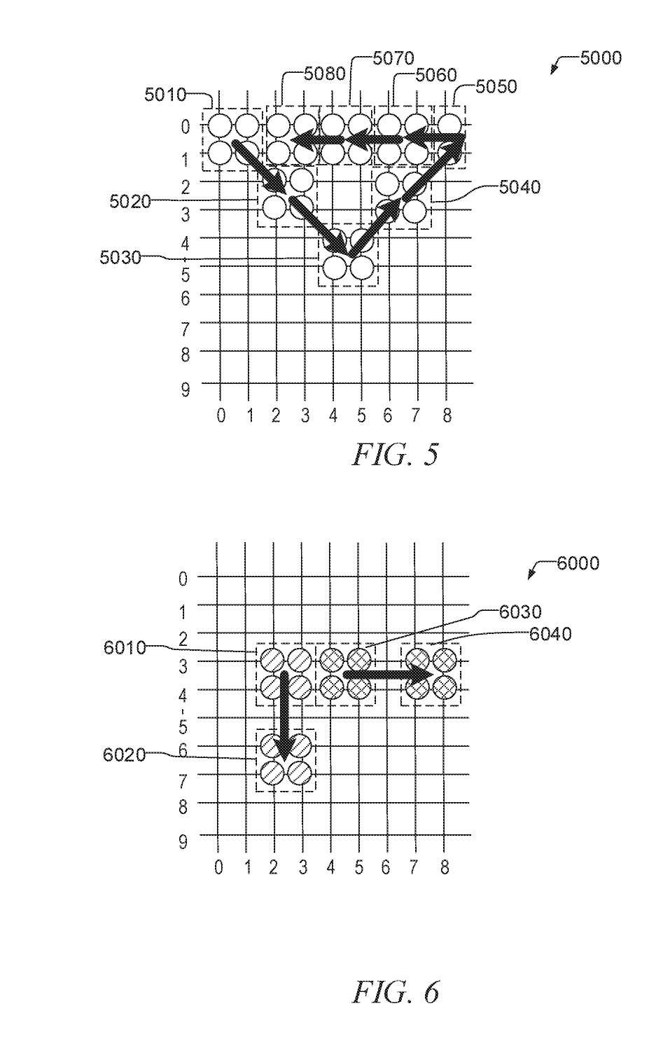

In other examples, a matrix of vibrators or electrical contacts may be provided, similar to the pin matrix of FIG. 3-4. Nonetheless, regardless of the precise implementation of the tactile reproduction units, as previously noted, the present disclosure envisages complex patterns of tactile communications. FIG. 5 shows a diagram of one example tactile sequence 5000 of eight touch points 5010-5080 according to some examples of the present disclosure. Each touch point is enclosed in a dashed square of four dots. The sequence begins when a user touches the touch screen attempting to record a tactile sequence. The user first puts their finger on the first touch point 5010 activating sensors at positions (0,0) (1,0), (0,1), and (1,1). The mobile device records the touch characteristics of this touch point. For example, the position (0,0; 1,0; 0,1; 1,1), pressure, warmth, and the like. The mobile device then records the time the user's finger remains on the touch point 5010. Once the user's finger transitions to the second touch point 5020, the touch characteristics of that touch point are recorded. As before, the time length that the user's finger remains on the touch point 5010 is recorded (e.g., as part of the sequence characteristics). This process repeats through touch points 5030, 5040, 5050, 5060, 5070, and 5080 until the user is done recording the tactile sequence. Then, when reproducing the tactile sequence, the sequence is replayed but instead of sensing with the touchscreen sensors the touch characteristics, the touch characteristics are reproduced using the tactile reproduction units. For example, the tactile reproduction units at positions (0,0) (1,0), (0,1), and (1,1) activate according to the touch characteristics of that point (e.g., intensity, warmth). Then the mobile device sets a timer to reproduce the amount of time between the first and second touch points (as recorded by the user). Once the timer expires, the tactile reproduction units reproduce touch point 5020 and so on, until the tactile sequence is complete. Through the disclosed tactile communications, complex patterns of touch may be utilized to convey different meanings. For example, the user may initially set one pattern may mean that the user has email, another pattern may mean that the user has a text. Then, in response to an event (e.g., a received email), the pattern may be replayed using the tactile reproduction units. Indeed patterns may even translate to language. For example, a pattern may send the message “I'm hungry,” or “I'm tired.” In some examples, a user's input of a tactile sequence may be quickly transmitted (e.g., “streamed” in real time or near-real time) to a second device over a network which may reproduce it immediately. Thus, the second device's tactile reproduction units are “mirroring” the first user's touch on the first device.

FIG. 6 shows another example tactile sequence 6000 of four touch points 6010-6040. In this example, there are two independent touch points (multi-touch) starting at 6010 and 6030 (shown by different shading). One finger slides down to 6020 and the other slides out to 6040. These may be recorded as one tactile sequence 6000 with four different touch points. This example illustrates that the touch points may be overlapping in time. This sequence may be reproduced by activation of tactile reproduction units in different areas in overlapping time periods.

As previously described, tactile sequences may be used as notifications (e.g., email, text, weather, application notifications, operating system notifications, time notifications, calendar notifications, fitness related notifications (heart rate, number of steps, and the like), and the like. In other examples, tactile sequences may be transmitted to another mobile device. For example, the data structure describing the tactile sequence may be packetized and transmitted. This may be done over a computer network wirelessly or wired. For example, the device may transmit the tactile sequence as readable text on one or more Short Message Service (SMS) messages—also known as text messages. An application on the recipient device may recognize the SMS as a tactile sequence and may play back the tactile sequence using the tactile reproduction units. In other examples, applications on each device have a common application-layer messaging protocol for sending and receiving tactile sequences. Users may utilize these tactile communications to discrete communicate as they would with a phone conversation, a text message, or the like. For example, individuals could communicate using an Instant Messaging, email, text messaging or other applications with touch instead of text.

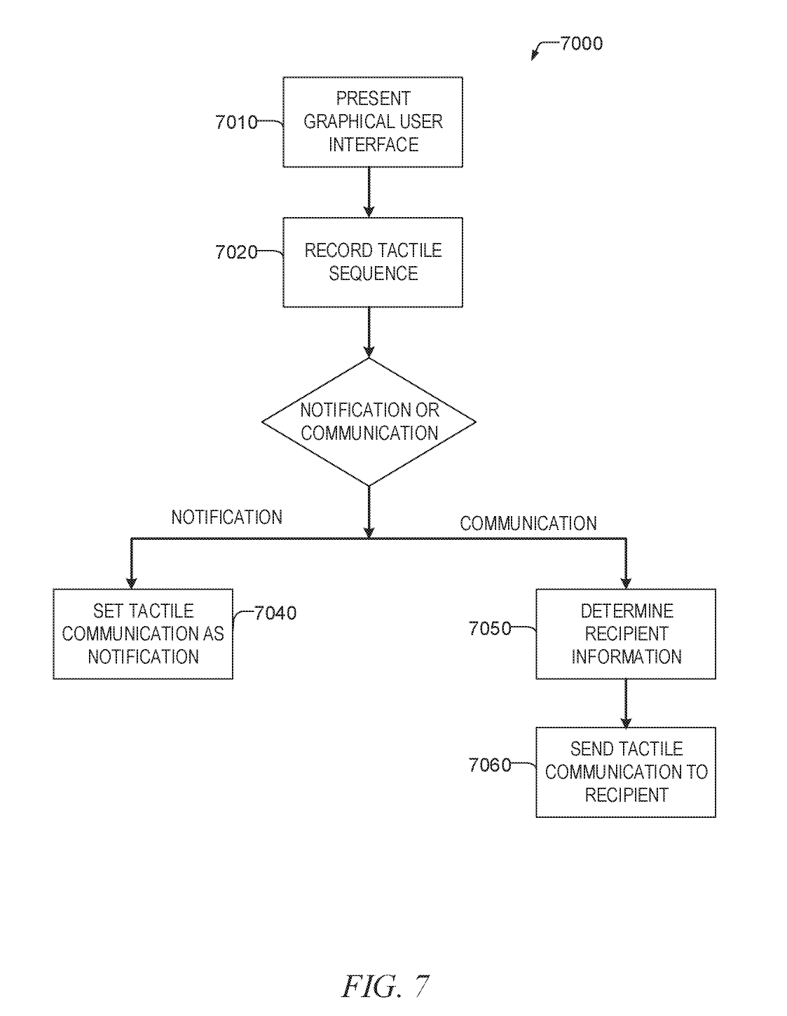

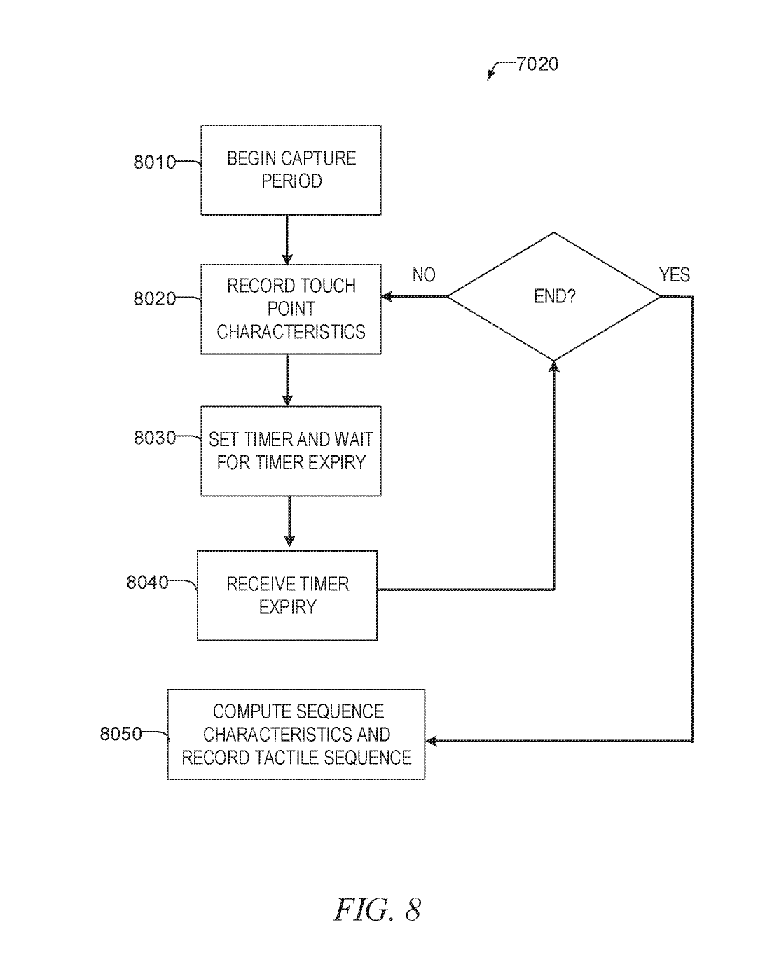

FIG. 7 shows a flowchart of a method 7000 of recording a tactile sequence according to some examples of the present disclosure. At operation 7010 the mobile device may present a graphical user interface (GUI). This may be an interface specifically designed for entering tactile sequences. The GUI may show on-screen the path of the tactile sequence as it is entered by the user to provide visual feedback to the user. Alternatively, the tactile reproduction units on the user's own device may preview the communication to the user. In yet other examples, no confirmation or reproduction is provided and indeed in some examples, no GUI may be provided.

At operation 7020 the mobile device may record the tactile sequence. If the tactile sequence is a notification, the mobile device may store the tactile sequence, and set the tactile communication as a notification at operation 7040. For example, the mobile device may store the tactile communication in a place where notifications are stored. Additionally the mobile device may modify a stored table that specifies which notifications to deliver when an event of a specific type is received so as to add the tactile notification to an event type selected by the user. The mobile device operating system may then play this tactile notification upon receipt of an event of the selected event type.

If the tactile sequence is to be used for communications, the mobile device may determine the recipient at operation 7050. The recipient may be determined based upon a previous recipient (e.g., the user may be in a “chat” session with another user). In other examples, the GUI may ask the user for the recipient. At operation 7060 the mobile device may send the tactile communication to the recipient. For example, using one or more communication protocols (e.g., Transmission Control Protocol (TCP), Internet Protocol (IP)) and the like.

FIG. 8 shows a sub-flowchart of a method of recording tactile information 7020 according to some examples of the present disclosure. At operation 8010 the mobile device may begin a capture period. For example, a tactile recordation control module executing on the mobile device may create one or more data structures to store the tactile sequence and initialize one or more variables. The capture period may be open ended; that is, the capture period may continue until a user input indicates that the user is done capturing tactile information. In other examples, the capture period may be only open for a determined (e.g., preset) period of time. At operation 8020 the mobile device may record touch point characteristics for each touch sensed. For example sensors that detect the location, pressure, warmth, and the like of the touch may be polled and their results may be recorded as touch point characteristics of the tactile sequence. Multiple sensed touches may be collected—that is, if two or more touches are sensed, the sensors may be read for each touch point. The system also notes a relative timing of the touch inputs with respect to the beginning of the capture period.

At operation 8030 the system sets a timer and begins waiting for the timer expiry. The timer may be a relatively short timer and in some examples, may be correlated with a desired tactile resolution. For example, shorter timers may allow for more fine-grained tactile inputs but may require additional processing resources. At operation 8040, the timer expires and if the sequence is not over (e.g., through the expiry of a second timer on the entire sequence (not shown in the Figure for clarity) the mobile device may record more touch point characteristics for additional touch points in the sequence. Once the tactile sequence is over, at operation 8050 the sequence characteristics are computed and the tactile sequence is stored (e.g., on a storage device or Random Access Memory (RAM) of the mobile device).

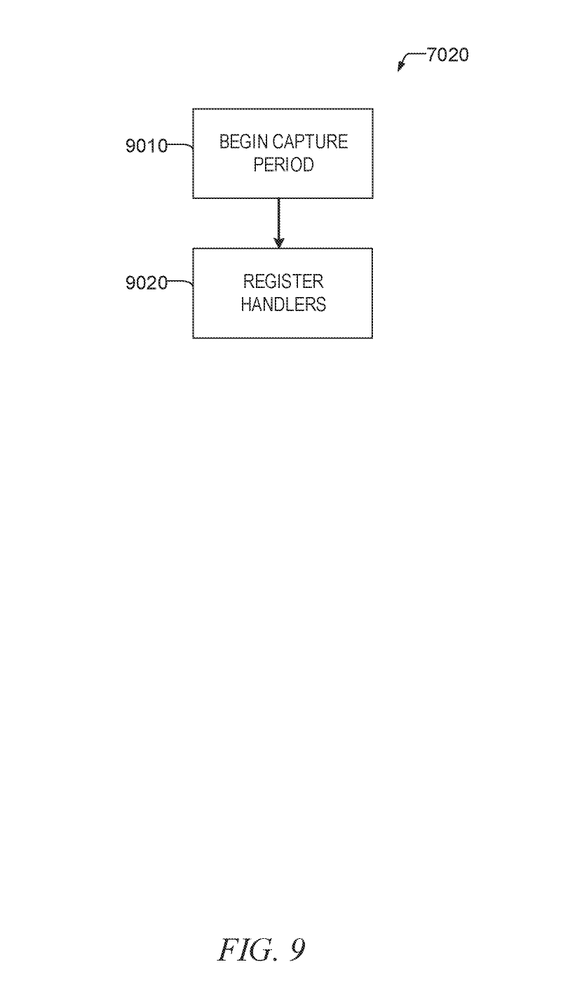

While FIG. 8 illustrated an example in which a timer controls the resolution of the tactile sequence, in other examples, an event driven architecture may be used. FIGS. 9-11 shows sub-flowcharts of an example method of recording tactile information 7020 using events according to some examples of the present disclosure. Turning to FIG. 9, at operation 9010 the capture period may start. For example, e.g., a tactile recordation control module executing on the mobile device may create one or more data structures to store the tactile sequence and initialize one or more variables to allow the tactile recordation control module to recognize that a tactile capture sequence is ongoing. In some examples, at operation 9020 the tactile recordation control module may also register one or more event handlers with an operating system of the mobile device to process events from one or more of the sensors of the mobile device—for example, register for touch events from the touch screen. Events (e.g., interrupts from sensors on the mobile device or the like) are handled by the operating system of the mobile device and an appropriate event handler is called depending on the event.

For example, the touch sensor may interrupt the processor when a movement or other change of the touch points is detected (or some other event). The processor then determines which functions are registered to receive the events and then route information about the event to those functions and begin executing those functions.

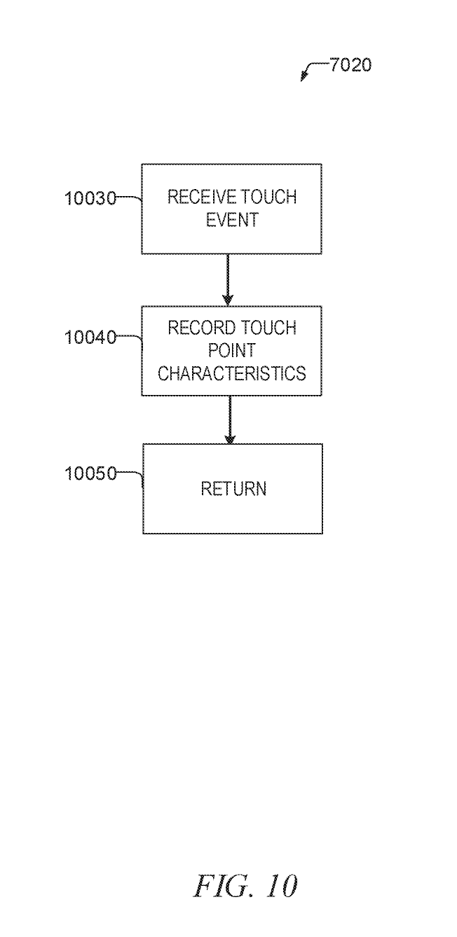

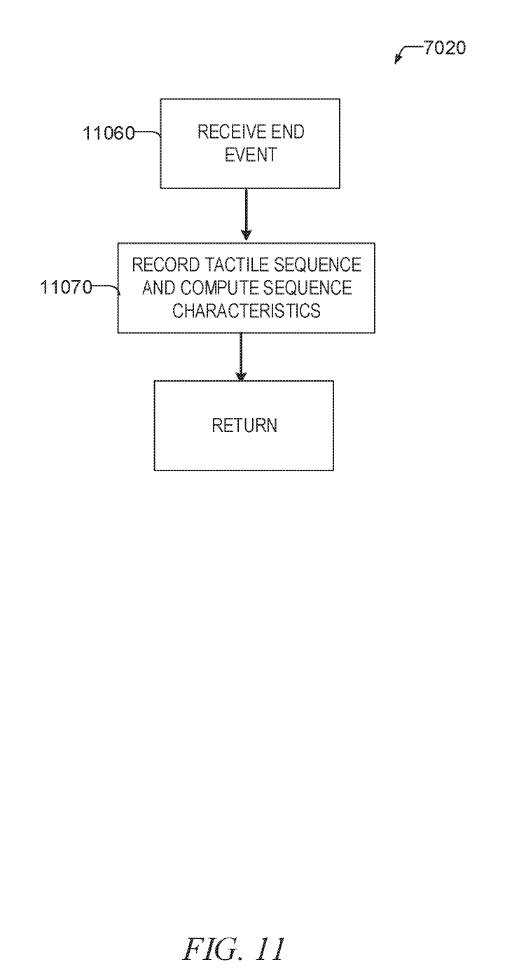

An example such function for touch events is shown in FIG. 10. At operation 10030, the event handler is executed and the touch event is received by the event handler. At operation 10040, the touch point characteristics are collected and recorded. At operation 10050 the event handler returns control back to the calling program.

Another such event handler is shown in FIG. 11. This event handler handles input or a timer expiry indicating an end of the capture sequence. At operation 11060 the event handler is executed and receives the event (either timer expiry or event indicating the capture sequence is over, such as a user press of an end capture button or the like). At operation 11070 the mobile device may record the tactile sequence and compute sequence characteristics. The event handler then returns control back to the calling program at operation 11080.

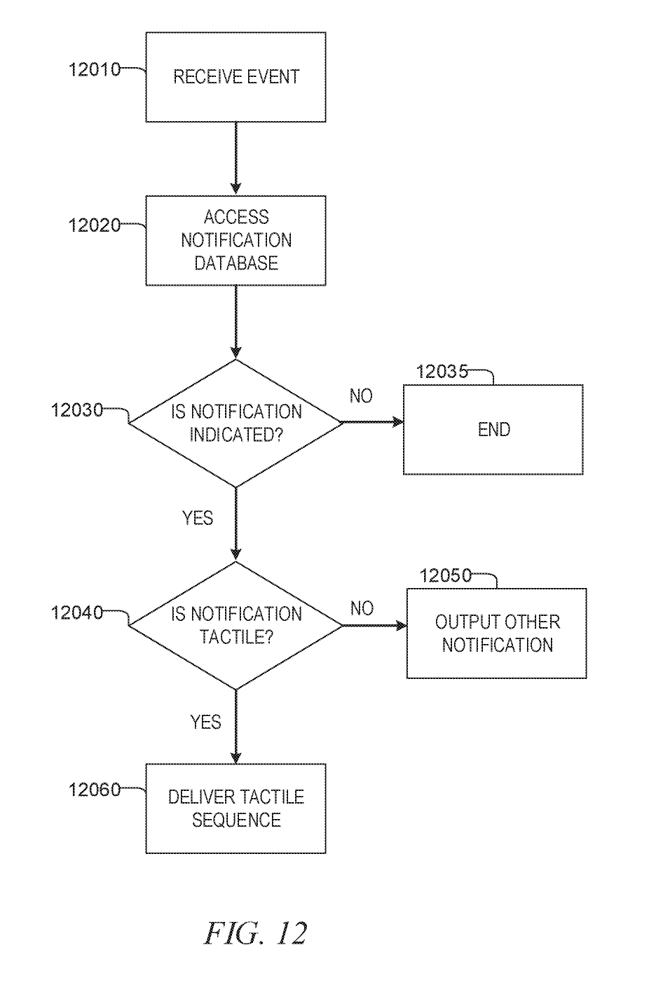

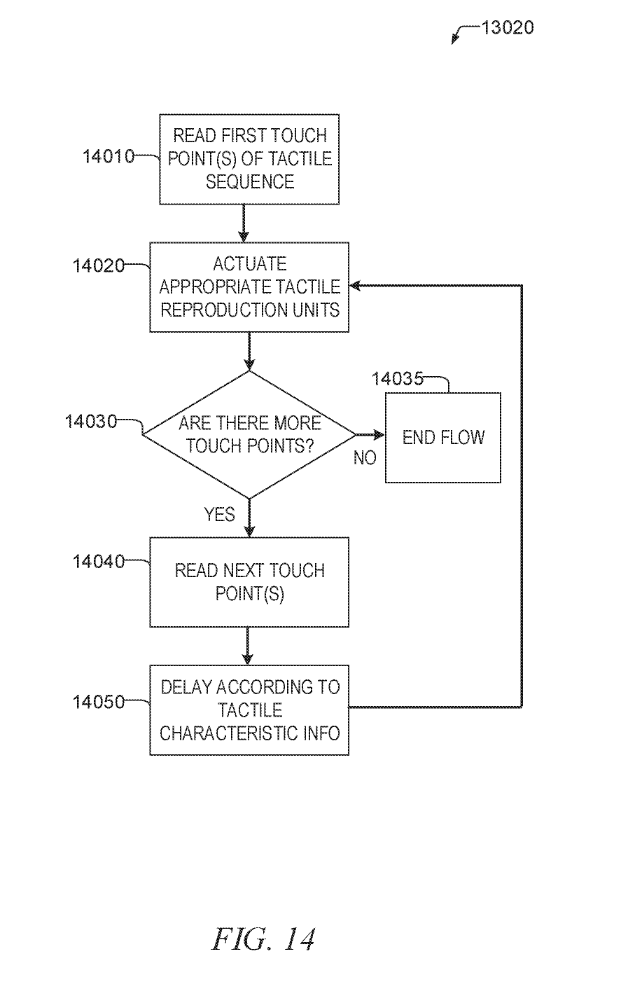

Turning now to FIG. 12, a flowchart of a method 12000 of utilizing a tactile sequence as a notification on a mobile device is shown according to some examples of the present disclosure. At operation 12010, the mobile device receives an event for which a notification is desired. For example, a new email, text message, phone call, instant message, notification from an installed application, or the like. At operation 12020 the mobile device accesses the notification database. The notification database lists events and the user's desired notification for those events. At operation 12030, a determination is made whether the notification database indicates that a notification is to be delivered at all (for example, users may wish not to receive a notification of the type received). If not, then at operation 12035, the flow ends. If there is a notification to deliver, the system then determines if the notification is a tactile notification at operation 12040. If it is not, then at operation 12050, the other notification is delivered. If it is, then at operation 12060, the tactile notification is delivered. The delivery of tactile notifications will be further described in FIG. 14.

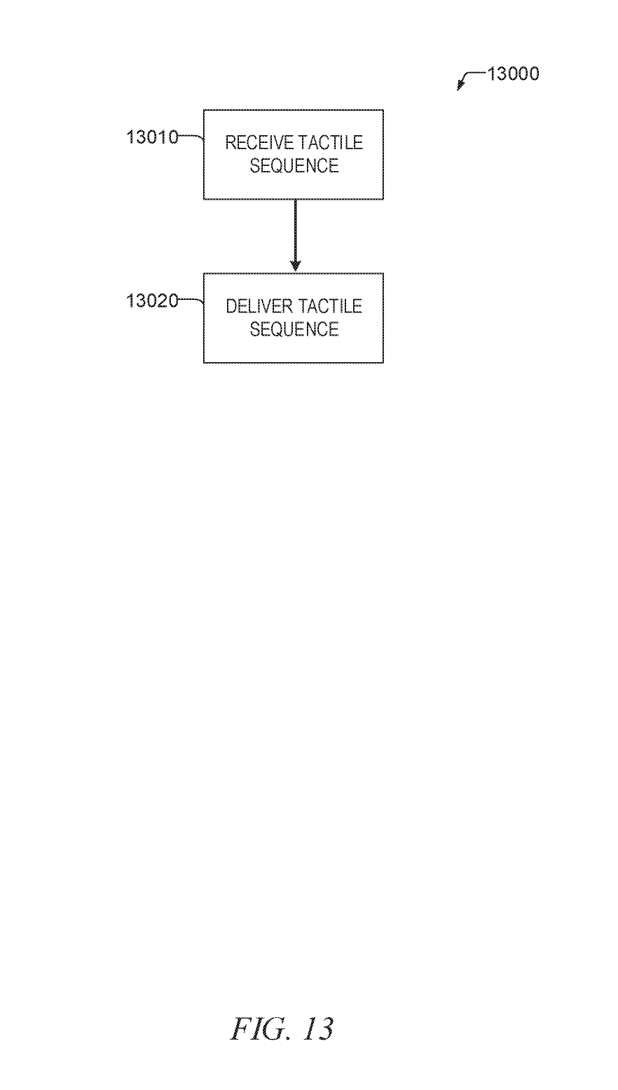

Turning now to FIG. 13, a flowchart of a method 13000 of receiving a tactile sequence as a communication from another user is shown according to some examples of the present disclosure. At operation 13010 the tactile sequence is received. For example, the tactile sequence could be received over a computer network as part of one or more packets using one or more packet-based communication protocols. Example communication protocols include protocols in a protocol stack. For example, protocols such as an Ethernet Protocol, Internet Protocol (IP), a Transmission Control Protocol (TCP) a HyperText Transfer Protocol (HTTP) and the like. Other protocols may be utilized, for example, wireless protocols such as Long Term Evolution (LTE) and LTE Advanced (LTE-A) protocols specified by the Third Generation Partnership Project (3GPP). At operation 13020 the tactile sequence may be delivered.

Turning now to FIG. 14, a sub-flowchart of a method 13020 of delivering a tactile sequence is shown according to some examples of the present disclosure. At operation 14010 the system reads characteristics of the first one or more touch point(s) of the tactile sequence. For example, the system opens a file or data structure containing the tactile sequence. Inside information on the characteristics of each touch point is stored. In some examples, the touch points are stored in order, or are not stored in order, but are stored with a descriptor indicating their order. At operation 14020, the mobile device actuates the tactile reproduction units according to the read touch point. For example, the tactile reproduction units may be a set of two or more tactile reproduction units and the tactile reproduction units may be a subset of two or more of the full set of tactile reproduction units. Actuating may include extending pins of the subset of the full set, turning on vibrators of the first subset, and turning on electrical current to the first subset. A next touch point may activate a second subset of tactile reproduction units, the second subset of tactile reproduction units being different that the first subset.

For example, pins at the location of the touch point are actuated. The pins may be actuated to a length corresponding to an intensity of the touch (e.g., the pressure of the person's finger on the touch screen at capture time). In examples in which the tactile reproduction units are vibrators, the vibrators at the location of the touch point are actuated. The vibration intensity may correspond to the sensed intensity of the touch at capture time (as specified in the touch characteristics). In still other examples, where the tactile reproduction units are electrical contacts, the contacts at the location of the touch point are actuated. The electrical intensity (e.g., volts) may correspond to the sensed intensity of the touch at capture time (as specified in the touch characteristics). Heating elements may be activated at the touch point to correspond with a warmth of the touch.

At operation 14030 a check is made to determine if additional touch points are present. If there are no more touch points, then at 14035 the flow ends. If there are more touch points, then the next touch point characteristics are read from the file or data structure at operation 14040. At operation 14050, the system may delay in presenting the next touch point as specified in either the touch characteristics (e.g., the timings of the next touch points) or the acceleration and speed characteristics of the tactile sequence (if necessary—in some examples there is no delay). Flow then proceeds to 14020.

In some examples, in reproducing the touch points, the coordinate system used in capturing the touch point may be mapped to the coordinate system of the tactile reproduction units. For this reason, the tactile sequence may have coordinate (x,y) minimum and maximum information stored or transmitted along with, or as part of the tactile sequence information. This may then be mapped to the coordinate system of the tactile reproduction units. For example, using the formula:

NewX=(Xtouch)*((ReproXMAX−ReproXMIN)/(CaptureXMAX−CaptureXMIN))

NewY=(Ytouch)*((ReproYMAX−ReproYMIN)/(CaptureYMAX−CaptureYMIN))

Where NewX and NewY are the coordinates on the tactile reproduction units, Xtouch and Ytouch are the (X,Y) coordinates of the capture device, ReproXMAX and ReproYMAX is the maximum X and Y values, respectively, of the tactile reproduction units, ReproXMIN and ReproYMIN is the minimum X and Y values, respectively, of the tactile reproduction units, CaptureXMAX and CaptureYMAX is the maximum X and Y values, respectively, of the capture sensors, CaptureXMIN and CaptureYMIN is the minimum X and Y values, respectively, of the capture sensors.

One of ordinary skill in the art with the benefit of the present disclosure will appreciate that other conversion formulas may be utilized instead of the previously described formula.

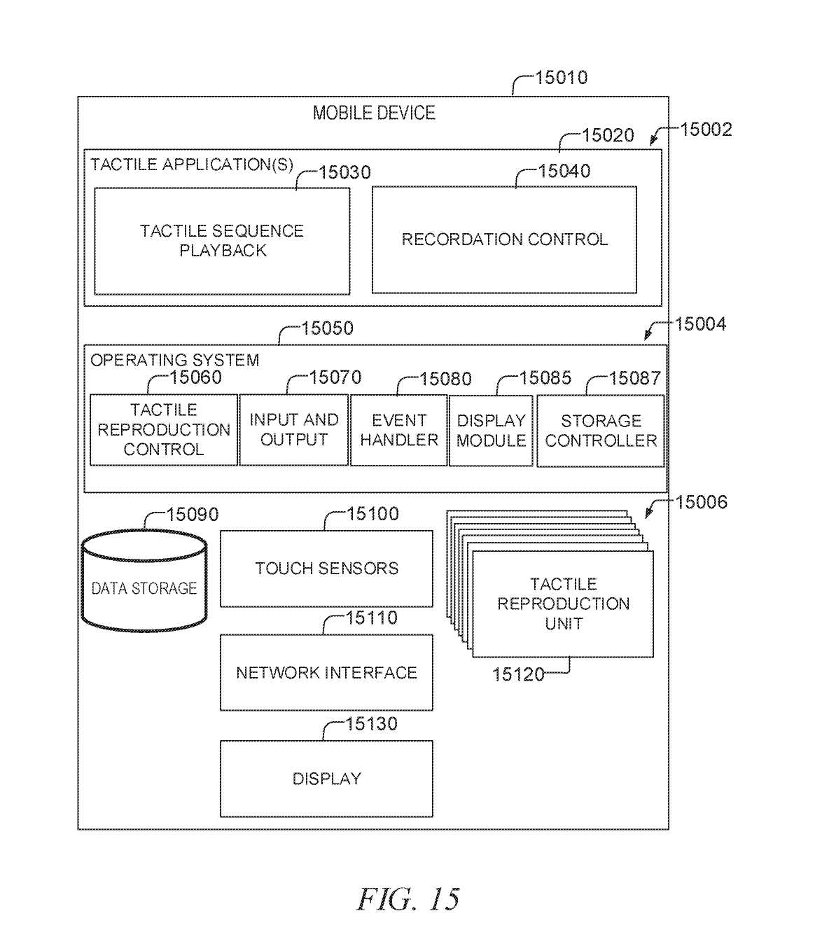

Turning now to FIG. 15, a logical schematic of a mobile device 15010 is shown according to some examples of the present disclosure. Mobile device 15010 may have an application layer 15002, an operating system layer 15004 and a hardware layer 15006. FIG. 15 is exemplary only and more or fewer layers may be utilized and with different components than shown. Application layer 15002 may include one or more tactile application modules 15020. Example tactile application modules include tactile sequence playback module 15030 which may, upon request (e.g., from the operating system 15050 to play back a notification, or in response to receipt of a tactile sequence from another mobile device) work with operating system 15050, and in particular tactile reproduction control module 15060 to control the tactile reproduction units 15120 to reproduce a tactile sequence. For example, tactile sequence playback module 15030, tactile reproduction control module 15060, tactile reproduction units 15120, and other modules may implement the techniques described in FIGS. 12-14.

Recordation control application 15040 may record one or more tactile sequences, for example into data store 15090 using the storage controller 15087 of the operating system 15050. Recordation control application 15040 may utilize input and output module 15070 of the operating system 15050 to read the state of one or more sensors, such as touch sensors 15100. Recordation control application 15040 may utilize display module 15085 to output instructions or other graphical user interfaces for capturing tactile sequences using display 15130.

Operating system 15050 may provide one or more services for applications in application layer 15002. Operating system 15050 may manage hardware of the mobile device 15010 including data storage 15090, touch sensors 15100, network interface 15110, display 15130, tactile reproduction units 15120, and others. Operating system 15050 may provide services such as memory allocation, memory management, inter-process communication, allocation of processor resources and the like for the mobile device 15010.

Tactile reproduction control module 15060 may control one or more tactile reproduction units 15120. For example, tactile reproduction control module 15060 may be a device driver for one or more tactile reproduction units 15120 that provides programmatic access for application layer 15002 programs and other modules in the operating system layer 15004 through an Application Programming Interface (API). Input and Output module 15070 may be a device driver and may read one or more sensors (such as touch sensors 15100) and provide that information to event handler module 15080, other modules in the operating system layer 15004, and other application layer 15002 programs through an API.

Event handler module 15080 may provide one or more APIs to applications in the application layer 15002 and other modules in the operating system layer 15004 to allow them to register to receive events. Event handler module 15080 may detect these events and transfer program flow control to the registered event handlers. Display module 15085 may be a display driver that provides an API to applications in the application layer 15002 and other modules in the operating system layer 15004 to allow them to write to the display 15130. Storage controller module 15087 may be a device driver that provides an API to applications in the application layer 15002 and other modules in the operating system layer 15004 for storing and retrieving data from the data storage device 15090.

Data storage device 15090 may include Solid State memory (e.g., a solid state drive (SSD)), Flash memory, a hard-disk, a magnetic memory, an optical memory, or the like. Touch sensors 15100 and display 15130 may be integrated into a touchscreen display. While touch sensors 15100 is shown, and touch input is used herein for generating tactile sequences, one of ordinary skill will appreciate that other types of input may be utilized, such as keyboard, mouse, stylus, trackpad, touchpad, and the like to input these tactile sequences. Touch sensors 15100 may be capacitive, resistive, optical, acoustic, or the like. Network interface 15110 provides one or more network connections to other mobile devices. Network interface 15110 may be a Wireless Local Area Network (WLAN) interface, a cellular interface (e.g., an LTE or LTE-A interface), Bluetooth interface, Near Field Communications interface, or the like. Display 15130 may be a Liquid Crystal Display (LCD), a Light Emitting Diode (LED) display, a cathode ray tube, or the like.

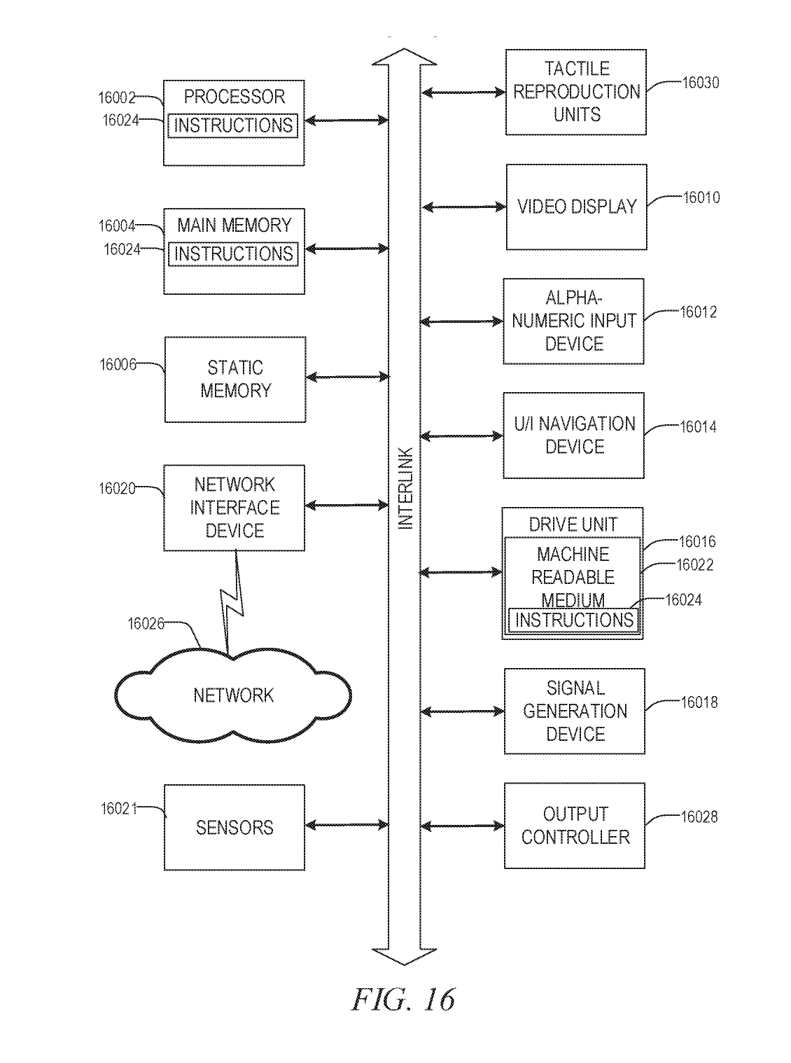

FIG. 16 illustrates a block diagram of an example machine 16000 upon which any one or more of the techniques (e.g., methodologies) discussed herein may perform. For example, FIG. 16 may be configured as in FIG. 15. That is, the machine in FIG. 16 may be configured to execute the application layer 15002 (including the tactile applications 15020), the Operating system layer 15004 with operating system 15050, and the like. Hardware in the hardware layer 15006 is shown in FIG. 16 as tactile reproduction units 16030 (tactile reproduction units 15120), static memory 16006, or main memory 16004 (data storage 15090), sensors 16021 or UI navigation device 16014 (touch sensors 15100), network interface device 16020 (network interface 15100), video display 16010 (display 15130), and the like. FIG. 16 includes additional details of the hardware of an exemplary mobile device on which the software of FIG. 15 configures the mobile device.

In alternative embodiments, the machine 16000 may operate as a standalone device or may be connected (e.g., networked) to other machines. In a networked deployment, the machine 16000 may operate in the capacity of a server machine, a client machine, or both in server-client network environments. In an example, the machine 16000 may act as a peer machine in peer-to-peer (P2P) (or other distributed) network environment. The machine 16000 may be a personal computer, a mobile device set-top box, a web appliance, a network router, switch or bridge, or any machine capable of executing instructions (sequential or otherwise) that specify actions to be taken to a machine. Machine 16000 may be a mobile device—e.g., a tablet PC, a personal digital assistant (PDA), a mobile telephone, a smart phone, a wearable (e.g., a smart watch) or the like. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 16000 may include a hardware processor 16002 (e.g., a central processing unit (CPU), a graphics processing unit (GPU), a hardware processor core, or any combination thereof), a main memory 16004 and a static memory 16006, some or all of which may communicate with each other via an interlink (e.g., bus) 16008. The machine 16000 may further include a display unit 16010, an alphanumeric input device 16012 (e.g., a keyboard), and a user interface (UI) navigation device 16014 (e.g., a mouse). In an example, the display unit 16010, input device 16012 and UI navigation device 16014 may be a touch screen display. The machine 16000 may additionally include a storage device (e.g., drive unit) 16016, a signal generation device 16018 (e.g., a speaker), a network interface device 16020, and one or more sensors 16021, such as a global positioning system (GPS) sensor, compass, accelerometer, or other sensor. The machine 16000 may include an output controller 16028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 16016 may include a machine readable medium 16022 on which is stored one or more sets of data structures or instructions 16024 (e.g., software) embodying or utilized by any one or more of the techniques or functions described herein. The instructions 16024 may also reside, completely or at least partially, within the main memory 16004, within static memory 16006, or within the hardware processor 16002 during execution thereof by the machine 16000. In an example, one or any combination of the hardware processor 16002, the main memory 16004, the static memory 16006, or the storage device 16016 may constitute machine readable media.

While the machine readable medium 16022 is illustrated as a single medium, the term “machine readable medium” may include a single medium or multiple media (e.g., a centralized or distributed database, and/or associated caches and servers) configured to store the one or more instructions 16024.

The term “machine readable medium” may include any medium that is capable of storing, encoding, or carrying instructions for execution by the machine 16000 and that cause the machine 16000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks.

In some examples, machine readable media may include non-transitory machine readable media. In some examples, machine readable media may include machine readable media that is not a transitory propagating signal.

The instructions 16024 may further be transmitted or received over a communications network 16026 using a transmission medium via the network interface device 16020. The Machine 16000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 16020 may include one or more physical jacks (e.g., Ethernet, coaxial, or phone jacks) or one or more antennas to connect to the communications network 16026. In an example, the network interface device 16020 may include a plurality of antennas to wirelessly communicate using at least one of single-input multiple-output (SIMO), multiple-input multiple-output (MIMO), or multiple-input single-output (MISO) techniques. In some examples, the network interface device 16020 may wirelessly communicate using Multiple User MIMO techniques.

### Other Notes and Examples

Example 1 is a computing device that provides a tactile user interface, the device comprising: a plurality of tactile reproduction units spatially separated across a skin-contacting surface of the computing device; a processor communicatively coupled with the plurality of tactile reproduction units; a memory, communicatively coupled with the processor and comprising instructions, that when performed by the processor, causes the processor to perform operations to: read characteristics of a first touch point of a tactile sequence; actuate a first subset of two or more tactile reproduction units of the plurality of tactile reproduction units according to the characteristics of the first touch point; reading characteristics of a next touch point of the tactile sequence; delaying a specified period of time; and actuating a second subset of tactile reproduction units of the plurality of tactile reproduction units according to the characteristics of the next touch point, the second subset of tactile reproduction units being different that the first subset.

In Example 2, the subject matter of Example 1 optionally includes wherein the instructions further comprise instructions, that when performed by the processor, causes the processor to perform further operations to: receive an event; and determine that the tactile sequence is a desired notification for the event; wherein the operations to read the characteristics of the first touch point of the tactile sequence, actuate the first subset of two or more tactile reproduction units of the plurality of tactile reproduction units, read the characteristics of the next touch point of the tactile sequence, delay the specified period of time, and actuate the second subset of tactile reproduction units is performed responsive to a determination that the tactile sequence is the desired notification for the event.

In Example 3, the subject matter of any one or more of Examples 1-2 optionally include wherein the instructions further comprise instructions, that when performed by the processor, causes the processor to perform further operations to: receive the tactile sequence from a second mobile device over a network.

In Example 4, the subject matter of any one or more of Examples 1-3 optionally include wherein the instructions further comprise instructions, that when performed by the processor, causes the processor to perform further operations to: begin a tactile sequence capture mode to capture a second tactile sequence; register an event handler to handle a touch event; at the event handler: receive an indication that the touch event occurred at the event handler; record a touch point characteristic in the second tactile sequence; and return control flow to a calling function.

In Example 5, the subject matter of any one or more of Examples 1-4 optionally include wherein the first subset of tactile reproduction units are pins extendable through a shaft and out an opening in a face of the computing device, and wherein the instructions to actuate the first subset of tactile reproduction units comprises instructions to extend pins of the first subset of tactile reproduction units out through the opening.

In Example 6, the subject matter of any one or more of Examples 1-5 optionally include wherein the first subset of tactile reproduction units are vibrators, and wherein the instructions to actuate the first subset of tactile reproduction units comprises instructions to turn on vibrators of the first subset of tactile reproduction units.

In Example 7, the subject matter of any one or more of Examples 1-6 optionally include wherein the first subset of tactile reproduction units are a plurality of electrical contacts and wherein the instructions to actuate the first subset of tactile reproduction units comprises instructions to turn on electrical current to the first subset of tactile reproduction units.

In Example 8, the subject matter of any one or more of Examples 1-7 optionally include wherein the characteristics of the touch point include a pressure characteristic and wherein the instructions to actuate the first subset of tactile reproduction units comprises instructions to extend pins of the first subset of the two or more tactile reproduction units a length determined based upon the pressure characteristic.

In Example 9, the subject matter of any one or more of Examples 1-8 optionally include wherein the characteristics of the touch point include a pressure characteristic and wherein the instructions to actuate the first subset of tactile reproduction units comprises instructions to apply a voltage applied to the first subset of the two or more tactile reproduction units based on the pressure characteristic.

In Example 10, the subject matter of any one or more of Examples 1-9 optionally include wherein the characteristics of the touch point include a pressure characteristic and wherein the instructions to actuate the first subset of tactile reproduction units comprises instructions to apply a vibration intensity to the first subset of the two or more tactile reproduction units based on the pressure characteristic.

Example 11 is a method for providing a tactile user interface on a computing device, the method comprising: reading characteristics of a first touch point of a tactile sequence; actuating a first subset of two or more tactile reproduction units of a plurality of tactile reproduction units according to the characteristics of the first touch point, the plurality of tactile reproduction units spatially separated across a skin-contacting surface of the computing device; reading characteristics of a next touch point of the tactile sequence; delaying a specified period of time; and actuating a second subset of tactile reproduction units of the plurality of tactile reproduction units according to the characteristics of the next touch point, the second subset of tactile reproduction units being different that the first subset.

In Example 12, the subject matter of Example 11 optionally includes receiving an event; and determining that the tactile sequence is a desired notification for the event; wherein the reading the characteristics of the first touch point of the tactile sequence, the actuating the first subset of two or more tactile reproduction units of the plurality of tactile reproduction units, the reading the characteristics of the next touch point of the tactile sequence, the delaying the specified period of time, and the actuating the second subset of tactile reproduction units is performed responsive to determining that the tactile sequence is the desired notification for the event.

In Example 13, the subject matter of any one or more of Examples 11-12 optionally include receiving the tactile sequence from a second mobile device over a network.

In Example 14, the subject matter of any one or more of Examples 11-13 optionally include beginning a tactile sequence capture mode to capture a second tactile sequence; registering an event handler to handle a touch event; at the event handler: receiving an indication that the touch event occurred at the event handler; recording a touch point characteristic in the second tactile sequence; and returning control flow to a calling function.

In Example 15, the subject matter of any one or more of Examples 11-14 optionally include wherein the first subset of tactile reproduction units are pins extendable through a shaft and out an opening in a face of the computing device, and wherein actuating the first subset of tactile reproduction units comprises extending pins of the first subset of tactile reproduction units out through the opening.

In Example 16, the subject matter of any one or more of Examples 11-15 optionally include wherein the first subset of tactile reproduction units are a plurality of vibrators, and wherein actuating the first subset of tactile reproduction units comprises turning on vibrators of the first subset of tactile reproduction units.

In Example 17, the subject matter of any one or more of Examples 11-16 optionally include wherein the first subset of tactile reproduction units are a plurality of electrical contacts and wherein actuating the first subset of tactile reproduction units comprises turning on electrical current to the first subset of tactile reproduction units.

In Example 18, the subject matter of any one or more of Examples 11-17 optionally include wherein the characteristics of the touch point include a pressure characteristic and wherein the actuating the first subset of the two or more tactile reproduction units of a plurality of tactile reproduction units according to the characteristics of the first touch point comprises extending pins of the first subset of the two or more tactile reproduction units a length determined based upon the pressure characteristic.

In Example 19, the subject matter of any one or more of Examples 11-18 optionally include wherein the characteristics of the touch point include a pressure characteristic and wherein the actuating the first subset of the two or more tactile reproduction units of a plurality of tactile reproduction units according to the characteristics of the first touch point comprises applying a voltage applied to the first subset of the two or more tactile reproduction units based on the pressure characteristic.

In Example 20, the subject matter of any one or more of Examples 11-19 optionally include wherein the characteristics of the touch point include a pressure characteristic and wherein the actuating the first subset of the two or more tactile reproduction units of a plurality of tactile reproduction units according to the characteristics of the first touch point comprises applying a vibration intensity to the first subset of the two or more tactile reproduction units based on the pressure characteristic.

Example 21 is at least one machine readable medium comprising instructions, that when performed by a machine, cause the machine to perform the operations of any one of Examples 11-20.

Example 22 is a computing device comprising means for performing the operations of any one of Examples 11-20.

Example 23 is at least one machine readable medium for providing a tactile user interface on a computing device, the machine readable medium comprising instructions, that when performed by the machine, cause the machine to perform operations to: read characteristics of a first touch point of a tactile sequence; actuate a first subset of two or more tactile reproduction units of a plurality of tactile reproduction units according to the characteristics of the first touch point, the plurality of tactile reproduction units spatially separated across a skin-contacting surface of the computing device, read characteristics of a next touch point of the tactile sequence; delay a specified period of time; and actuate a second subset of tactile reproduction units of the plurality of tactile reproduction units according to the characteristics of the next touch point, the second subset of tactile reproduction units being different that the first subset.

In Example 24, the subject matter of Example 23 optionally includes wherein the instructions further comprise instructions, that when performed by the machine, causes the processor to perform further operations to: receive an event; and determine that the tactile sequence is a desired notification for the event; wherein the instructions to read the characteristics of the first touch point of the tactile sequence, actuate the first subset of two or more tactile reproduction units of the plurality of tactile reproduction units, read the characteristics of the next touch point of the tactile sequence, delay the specified period of time, and actuate the second subset of tactile reproduction units is performed responsive to a determination that the tactile sequence is the desired notification for the event.

In Example 25, the subject matter of any one or more of Examples 23-24 optionally include wherein the instructions further comprise instructions, that when performed by the machine, causes the processor to perform further operations to: receive the tactile sequence from a second mobile device over a network.

In Example 26, the subject matter of any one or more of Examples 23-25 optionally include wherein the instructions further comprise instructions, that when performed by the machine, causes the processor to perform further operations to: begin a tactile sequence capture mode to capture a second tactile sequence; register an event handler to handle a touch event; at the event handler: receive an indication that the touch event occurred at the event handler; record a touch point characteristic in the second tactile sequence; and return control flow to a calling function.

In Example 27, the subject matter of any one or more of Examples 23-26 optionally include wherein the first subset of tactile reproduction units are pins extendable through a shaft and out an opening in a face of the computing device, and wherein the instructions to actuate the first subset of tactile reproduction units comprises instructions to extend pins of the first subset of tactile reproduction units out through the opening.

In Example 28, the subject matter of any one or more of Examples 23-27 optionally include wherein the first subset of tactile reproduction units are vibrators, and wherein the instructions to actuate the first subset of tactile reproduction units comprises instructions to turn on vibrators of the first subset of tactile reproduction units.

In Example 29, the subject matter of any one or more of Examples 23-28 optionally include wherein the first subset of tactile reproduction units are a plurality of electrical contacts and wherein the instructions to actuate the first subset of tactile reproduction units comprises instructions to turn on electrical current to the first subset of tactile reproduction units.

In Example 30, the subject matter of any one or more of Examples 23-29 optionally include wherein the characteristics of the touch point include a pressure characteristic and wherein the instructions to actuate the first subset of tactile reproduction units comprises instructions to extend pins of the first subset of the two or more tactile reproduction units a length determined based upon the pressure characteristic.

In Example 31, the subject matter of any one or more of Examples 23-30 optionally include wherein the characteristics of the touch point include a pressure characteristic and wherein the instructions to actuate the first subset of tactile reproduction units comprises instructions to apply a voltage applied to the first subset of the two or more tactile reproduction units based on the pressure characteristic.

In Example 32, the subject matter of any one or more of Examples 23-31 optionally include wherein the characteristics of the touch point include a pressure characteristic and wherein the instructions to actuate the first subset of tactile reproduction units comprises instructions to apply a vibration intensity to the first subset of the two or more tactile reproduction units based on the pressure characteristic.

Example 33 is a computing device that provides a tactile user interface, the device comprising: means for reading characteristics of a first touch point of a tactile sequence; means for actuating a first subset of two or more tactile reproduction units of a plurality of tactile reproduction units according to the characteristics of the first touch point, the plurality of tactile reproduction units spatially separated across a skin-contacting surface of the computing device; means for reading characteristics of a next touch point of the tactile sequence; means for delaying a specified period of time; and means for actuating a second subset of tactile reproduction units of the plurality of tactile reproduction units according to the characteristics of the next touch point, the second subset of tactile reproduction units being different that the first subset.

In Example 34, the subject matter of Example 33 optionally includes means for receiving an event; and means for determining that the tactile sequence is a desired notification for the event; wherein the reading the characteristics of the first touch point of the tactile sequence, the actuating the first subset of two or more tactile reproduction units of the plurality of tactile reproduction units, the reading the characteristics of the next touch point of the tactile sequence, the delaying the specified period of time, and the actuating the second subset of tactile reproduction units is performed responsive to determining that the tactile sequence is the desired notification for the event.

In Example 35, the subject matter of any one or more of Examples 33-34 optionally include means for receiving the tactile sequence from a second mobile device over a network.

In Example 36, the subject matter of any one or more of Examples 33-35 optionally include means for beginning a tactile sequence capture mode to capture a second tactile sequence; means for registering an event handler to handle a touch event; at the event handler: means for receiving an indication that the touch event occurred at the event handler; means for recording a touch point characteristic in the second tactile sequence; and means for returning control flow to a calling function.

In Example 37, the subject matter of any one or more of Examples 33-36 optionally include wherein the first subset of tactile reproduction units are pins extendable through a shaft and out an opening in a face of the computing device, and wherein the means for actuating the first subset of tactile reproduction units comprises means for extending pins of the first subset of tactile reproduction units out through the opening.

In Example 38, the subject matter of any one or more of Examples 33-37 optionally include wherein the first subset of tactile reproduction units are a plurality of vibrators, and wherein means for actuating the first subset of tactile reproduction units comprises means for turning on vibrators of the first subset of tactile reproduction units.

In Example 39, the subject matter of any one or more of Examples 33-38 optionally include wherein the first subset of tactile reproduction units are a plurality of electrical contacts and wherein means for actuating the first subset of tactile reproduction units comprises means for turning on electrical current to the first subset of tactile reproduction units.

In Example 40, the subject matter of any one or more of Examples 33-39 optionally include wherein the characteristics of the touch point include a pressure characteristic and wherein the means for actuating the first subset of the two or more tactile reproduction units of a plurality of tactile reproduction units according to the characteristics of the first touch point comprises means for extending pins of the first subset of the two or more tactile reproduction units a length determined based upon the pressure characteristic.

In Example 41, the subject matter of any one or more of Examples 33-40 optionally include wherein the characteristics of the touch point include a pressure characteristic and wherein the means for actuating the first subset of the two or more tactile reproduction units of a plurality of tactile reproduction units according to the characteristics of the first touch point comprises means for applying a voltage applied to the first subset of the two or more tactile reproduction units based on the pressure characteristic.

In Example 42, the subject matter of any one or more of Examples 33-41 optionally include wherein the characteristics of the touch point include a pressure characteristic and wherein the means for actuating the first subset of the two or more tactile reproduction units of a plurality of tactile reproduction units according to the characteristics of the first touch point comprises means for applying a vibration intensity to the first subset of the two or more tactile reproduction units based on the pressure characteristic.

What is claimed is:

1. A computing device that provides a tactile user interface, the device comprising:
a plurality of tactile reproduction units spatially separated across a skin-contacting surface of the computing device;
a processor communicatively coupled with the plurality of tactile reproduction units;
a memory, communicatively coupled with the processor and comprising instructions, that when performed by the processor, causes the processor to perform operations to:
read characteristics of a first touch point of a tactile sequence;
actuate a first subset of two or more tactile reproduction units of the plurality of tactile reproduction units according to the characteristics of the first touch point;
reading characteristics of a next touch point of the tactile sequence;
delaying a specified period of time; and
actuating a second subset of tactile reproduction units of the plurality of tactile reproduction units according to the characteristics of the next touch point, the second subset of tactile reproduction units being different that the first subset.

2. The computing device of claim 1, wherein the instructions further comprise instructions, that when performed by the processor, causes the processor to perform further operations to:
receive an event; and
determine that the tactile sequence is a desired notification for the event;
wherein the operations to read the characteristics of the first touch point of the tactile sequence, actuate the first subset of two or more tactile reproduction units of the plurality of tactile reproduction units, read the characteristics of the next touch point of the tactile sequence, delay the specified period of time, and actuate the second subset of tactile reproduction units is performed responsive to a determination that the tactile sequence is the desired notification for the event.

3. The computing device of claim 1, wherein the instructions further comprise instructions, that when performed by the processor, causes the processor to perform further operations to:
receive the tactile sequence from a second mobile device over a network.

4. The computing device of claim 1, wherein the instructions further comprise instructions, that when performed by the processor, causes the processor to perform further operations to:
begin a tactile sequence capture mode to capture a second tactile sequence;
register an event handler to handle a touch event;
at the event handler:
receive an indication that the touch event occurred at the event handler;
record a touch point characteristic in the second tactile sequence; and
return control flow to a calling function.

5. The computing device of claim 1, wherein the first subset of tactile reproduction units are pins extendable through a shaft and out an opening in a face of the computing device, and wherein the instructions to actuate the first subset of tactile reproduction units comprises instructions to extend pins of the first subset of tactile reproduction units out through the opening.

6. The computing device of claim 1, wherein the first subset of tactile reproduction units are vibrators, and wherein the instructions to actuate the first subset of tactile reproduction units comprises instructions to turn on vibrators of the first subset of tactile reproduction units.

7. The computing device of claim 1, wherein the first subset of tactile reproduction units are a plurality of electrical contacts and wherein the instructions to actuate the first subset of tactile reproduction units comprises instructions to turn on electrical current to the first subset of tactile reproduction units.

8. The computing device of claim 1, wherein the characteristics of the touch point include a pressure characteristic and wherein the instructions to actuate the first subset of tactile reproduction units comprises instructions to extend pins of the first subset of the two or more tactile reproduction units a length determined based upon the pressure characteristic.

9. The computing device of claim 1, wherein the characteristics of the touch point include a pressure characteristic and wherein the instructions to actuate the first subset of tactile reproduction units comprises instructions to apply a voltage applied to the first subset of the two or more tactile reproduction units based on the pressure characteristic.

10. The computing device of claim 1, wherein the characteristics of the touch point include a pressure characteristic and wherein the instructions to actuate the first subset of tactile reproduction units comprises instructions to apply a vibration intensity to the first subset of the two or more tactile reproduction units based on the pressure characteristic.

11. A method for providing a tactile user interface on a computing device, the method comprising:
reading characteristics of a first touch point of a tactile sequence;
actuating a first subset of two or more tactile reproduction units of a plurality of tactile reproduction units according to the characteristics of the first touch point, the plurality of tactile reproduction units spatially separated across a skin-contacting surface of the computing device;
reading characteristics of a next touch point of the tactile sequence;
delaying a specified period of time; and
actuating a second subset of tactile reproduction units of the plurality of tactile reproduction units according to the characteristics of the next touch point, the second subset of tactile reproduction units being different that the first subset.

12. The method of claim 11, comprising:
receiving an event; and
determining that the tactile sequence is a desired notification for the event; wherein the reading the characteristics of the first touch point of the tactile sequence, the actuating the first subset of two or more tactile reproduction units of the plurality of tactile reproduction units, the reading the characteristics of the next touch point of the tactile sequence, the delaying the specified period of time, and the actuating the second subset of tactile reproduction units is performed responsive to determining that the tactile sequence is the desired notification for the event.

13. The method of claim 11, comprising:
receiving the tactile sequence from a second mobile device over a network.

14. The method of claim 11, comprising:
beginning a tactile sequence capture mode to capture a second tactile sequence;
registering an event handler to handle a touch event;
at the event handler:
receiving an indication that the touch event occurred at the event handler;
recording a touch point characteristic in the second tactile sequence; and
returning control flow to a calling function.

15. The method of claim 11, wherein the first subset of tactile reproduction units are pins extendable through a shaft and out an opening in a face of the computing device, and wherein actuating the first subset of tactile reproduction units comprises extending pins of the first subset of tactile reproduction units out through the opening.

16. The method of claim 1, wherein the first subset of tactile reproduction units are a plurality of vibrators, and wherein actuating the first subset of tactile reproduction units comprises turning on vibrators of the first subset of tactile reproduction units.

17. The method of claim 11, wherein the first subset of tactile reproduction units are a plurality of electrical contacts and wherein actuating the first subset of tactile reproduction units comprises turning on electrical current to the first subset of tactile reproduction units.

18. The method of claim 11, wherein the characteristics of the touch point include a pressure characteristic and wherein the actuating the first subset of the two or more tactile reproduction units of a plurality of tactile reproduction units according to the characteristics of the first touch point comprises extending pins of the first subset of the two or more tactile reproduction units a length determined based upon the pressure characteristic.

19. The method of claim 11, wherein the characteristics of the touch point include a pressure characteristic and wherein the actuating the first subset of the two or more tactile reproduction units of a plurality of tactile reproduction units according to the characteristics of the first touch point comprises applying a voltage applied to the first subset of the two or more tactile reproduction units based on the pressure characteristic.

20. The method of claim 11, wherein the characteristics of the touch point include a pressure characteristic and wherein the actuating the first subset of the two or more tactile reproduction units of a plurality of tactile reproduction units according to the characteristics of the first touch point comprises applying a vibration intensity to the first subset of the two or more tactile reproduction units based on the pressure characteristic.

21. At least one machine readable medium for providing a tactile user interface on a computing device, the machine readable medium comprising instructions, that when performed by the machine, cause the machine to perform operations to:
read characteristics of a first touch point of a tactile sequence;
actuate a first subset of two or more tactile reproduction units of a plurality of tactile reproduction units according to the characteristics of the first touch point, the plurality of tactile reproduction units spatially separated across a skin-contacting surface of the computing device;
read characteristics of a next touch point of the tactile sequence;
delay a specified period of time; and
actuate a second subset of tactile reproduction units of the plurality of tactile reproduction units according to the characteristics of the next touch point, the second subset of tactile reproduction units being different that the first subset.

22. The machine readable medium of claim 21, wherein the instructions further comprise instructions, that when performed by the machine, causes the processor to perform further operations to:
receive an event; and
determine that the tactile sequence is a desired notification for the event;
wherein the instructions to read the characteristics of the first touch point of the tactile sequence, actuate the first subset of two or more tactile reproduction units of the plurality of tactile reproduction units, read the characteristics of the next touch point of the tactile sequence, delay the specified period of time, and actuate the second subset of tactile reproduction units is performed responsive to a determination that the tactile sequence is the desired notification for the event.

23. The machine readable medium of claim 21, wherein the instructions further comprise instructions, that when performed by the machine, causes the processor to perform further operations to:
receive the tactile sequence from a second mobile device over a network.

24. The machine readable medium of claim 21, wherein the instructions further comprise instructions, that when performed by the machine, causes the processor to perform further operations to:
begin a tactile sequence capture mode to capture a second tactile sequence;
register an event handler to handle a touch event;
at the event handler:
receive an indication that the touch event occurred at the event handler;
record a touch point characteristic in the second tactile sequence; and
return control flow to a calling function.

25. The machine readable medium of claim 21, wherein the first subset of tactile reproduction units are pins extendable through a shaft and out an opening in a face of the computing device, and wherein the instructions to actuate the first subset of tactile reproduction units comprises instructions to extend pins of the first subset of tactile reproduction units out through the opening.
